(19) United States
(12) Patent Application Publication
(10) Pub. No.: US 2016/0063890 A1
(43) Pub. Date: Mar. 3, 2016

(54) METHOD FOR TRAINING BEHAVIOR

(71) Applicant: Maneesh SETHI, Boston, MA (US)

(72) Inventor: Maneesh SETHI, Boston, MA (US)

(21) Appl. No.: 14/838,790

(22) Filed: Aug. 28, 2015

Related U.S. Application Data
(63) Continuation-in-part of application No. 14/641,212, filed on Mar. 6, 2015.
(60) Provisional application No. 62/042,855, filed on Aug. 28, 2014.

(51) Int. Cl. G09B 19/00; G09B 5/06

(52) U.S. Cl. CPC G09B 19/00; G09B 5/06

(57) ABSTRACT

A wearable or other portable device in the form of a module, bracelet, anklet, ring, watchband, part of watchband, necklace, or part of a garment, is worn or carried by a user in order to assist in behavioral training of a user. The device produces one or more stimuli: for example, it may display words on an LED screen, emit a sound, shine a light, vibrate, induce a warming or cooling sensation, or induce a shock. The user may control the device's operation by manually administering stimuli via the device, or the user may choose or create a program through which the device automatically produces stimuli in response to particular criteria detected by the device or another computer linked to the device. A method for behavioral reinforcement involving use of the device.

### CROSS-REFERENCE TO RELATED APPLICATIONS

This patent claims priority to and incorporates fully by reference U.S. Provisional Patent Application No. 62/042,885, filed Aug. 28, 2015. This application is also a continuation in part of U.S. patent application Ser. No. 14/641,212 filed on Mar. 6, 2015, which claims priority to U.S. Provisional Patent Application No. 61/948,758 filed on Mar. 6, 2014.

### FIELD OF THE INVENTION

This patent relates to the field of wearable or otherwise portable memory improvement and habit training devices. The devices assist the user in memorizing facts or forming a habitual behavior (or eliminating habitual behavior) via various stimuli inducible on the user both automatically and manually.

### BACKGROUND OF THE INVENTION

A known method for habit formation, disclosed in PCT Application Pub. No. WO 2005/029242 A2, provides for a system for monitoring and managing body weight and other physiological conditions including iterative and personalized planning, intervention and reporting capability. It uses a body-mounted sensing apparatus for monitoring the person's behavior by comparing the predetermined suggested actions and the real activity.

Another known method, disclosed in U.S. Patent Application Pub. No. 2007/0216537 A1, provides for an alarm system attached to a user's body with silent alarm capability, responsive to wake-up alarms and to emergency sensors such as intrusion detectors. The user is wakened with a silent and safe local electric shock in response to a base unit wireless connection. The base unit utilizes an internal alarm clock and interfaces with a large variety of sensors and detectors, and may be programmed by the user for personal preferences. A vibration awakening means is also disclosed for use in conjunction with the electric shock awakening means.

Yet another known device and method, disclosed in U.S. Patent Application Pub. No. 6,445,303 B1 provides for an apparatus and method for waking a sleeping driver of a motor vehicle by administering an electric shock to the driver. The method disclosed determines whether a driver has fallen asleep by either monitoring the driver's pulse, the orientation and position of the driver's head with respect to at least two planes of movement, or the movement of the driver's eyes. The electric shock is administered by an element integrated in or coupled to the vehicle steering wheel, or by an element worn by the driver or secured to the driver's clothing.

Yet another known device, disclosed in U.S. Patent Application Pub. No. 2007/0080812 A1, provides for an apparatus for monitoring and discouraging trichotillomania and other unwanted behaviors. The disclosed prior art device includes a proximity detector, an event logger, and a user input facilitating event characterization. The apparatus further includes a device operative to alert the user in response to the output signal generated by the proximity detector—the alert may include tactile feedback such as mild electric shock.

Furthermore, electroconvulsive therapy (ECT), formerly known as electroshock therapy, and often referred to as shock treatment, is a standard psychiatric treatment in which seizures are electrically induced in patients to provide relief from psychiatric illnesses. A usual course of ECT involves multiple administrations, typically given two or three times per week until the patient is no longer suffering symptoms. It should be noted that the shock delivered by the present invention is significantly mild compared to the shock involved in ECT and is entirely safe.

### SUMMARY OF THE INVENTION

The present invention comprises a method and devices for performing said method. The method comprises various steps for enhancing the memory of a user of the device, or alternatively, various steps for training for or against habitual behaviors.

The invention discloses a method for enhancing a memory within a user, comprising receiving sensory information and forming a memory (thus, a first response within the user), and simultaneously, or very near in time, administering a sensory impact from a stimulating device carried by the user. When this occurs at nearly the same time (plus or minus 5 seconds), the memory is strengthened due to an emotional response from the administered impact being linked to the first informational response within the user's brain.

In other aspects of the invention, a method for enhancing memory within a user comprises receiving a first block of information in a sensory manner, the information forming a first memory and a first informational response within the user, simultaneously administering a first sensory impact from a stimulating device carried by the user, so that the first memory is strengthened due to an associated first emotional response from the first sensory impact being linked to the first informational response. The method continues in that the user receives a second block of information in a sensory manner, where the information forms a second memory and a second informational response within the user. The simultaneous administering of a second and different sensory impact from the stimulating device carried by the user creates a second memory that is strengthened due to an associated second emotional response from the second sensory impact being linked to the second informational response.

In some aspects, the method further comprises the step of re-administering the first or second sensory impact to assist a user to recollect a memory associated with the sensory impact.

In some aspects, the method the first sensory impact is a vibration and the second sensory impact is a mild electric shock.

In some aspects, the first sensory impact is a heating sensation and the second sensory impact is a cooling sensation.

In some aspects, both sensory impacts are electric shocks of varying degrees.

In some aspects, more than two sensory impacts are administered (any number of impacts is possible).

In some aspects, a method for training habitual behavior comprises administering a rewarding sensory impact (including a pattern of stimuli or a sound that is associated with reward) via a device worn by a user when the user performs a beneficial habitual behavior, and administering a punishing sensory impact via the device when a user performs a detrimental habitual behavior. Thus, the rewarding or punishing sensory impacts create an emotional response within the user, and the emotional response is linked to a particular behavior which the user desires to attain or avoid.

In some aspects, the punishing sensory impact comprises an electric shock.

In some aspects, the rewarding sensory impact comprises audio, heat, cool, a slight vibration to the wrist, a TENS (Transcutaneous electric nerve stimulation), the electric stimulation, which feels like a massage or other.

In some aspects, the administering is manually controlled by the user.

In some aspects, the administering is automatically controlled by the device or a connected computer via input detected by one or more sensors located on the device or externally to the device.

In some aspects, the device administers an automatic impact, the automatic impact occurring when the user is pointed in a particular compass direction, thus training the user's natural orientation.

In some aspects, the automatic impact can be used to train users of a sixth sense. A sixth sense is defined as subconscious awareness of data and information.

Some examples of sixth senses include: directional orientation, time, location, fluctuations in markets and rates, and more.

One exemplary example of a sixth sense is the ability to read SMS messages or text of any format via vibration patterns, as in Morse Code.

In some aspects, the administering is controlled remotely by another person.

In some aspects, the punishing sensory impact comprises a first vibration, the vibration acting as a warning to the user, and a second electric shock, the shock acting as a higher level of punishment. Vibration also may be used as a positive indicator or a reminder.

In some aspects, the invention comprises a wearable or carried device for memory enhancement, comprising a processing unit for receiving and sending signals to and from a computer, a stimulating unit for impacting a user wearing the device with an electric shock, the electric shock being self-induced by the user via a linked smartphone or a button located directly on the device, the electric shock being induced simultaneously with a receiving of information, the electric shock forming an emotional response within the user, the emotional response being linked in time and place to said receiving of information, and thus enhancing a memory of the information received within the user's brain.

In some aspects, the device further comprises a second stimulating unit for impacting a user wearing the device with a second stimulus, the second stimulus being a vibration.

In some aspects, the device further comprises a third stimulating unit for impacting a user wearing the device with a third stimulus, the third stimulus being an LED display.

In some aspects, the device further comprises a fourth stimulating unit for impacting a user wearing the device with a fourth stimulus, the fourth stimulus being a hot or cold sensation.

In some aspects, each stimulating unit administers impacts of varying degrees upon the user.

In some aspects, a speaker is used as a notifier, reward, warning and punishment.

### BRIEF DESCRIPTION OF THE DRAWINGS

FIG. 1 shows the steps for one embodiment of the present method used to improve or enhance a user's memory.

FIG. 2 shows the steps for one embodiment of the present method used to train habitual behavior.

FIG. 3 shows the steps of another embodiment of the present method used to improve or enhance a user's memory, used in situations where a larger volume of information is learned.

FIG. 4 shows one embodiment, in an exploded view, of a device used to employ the method of the present invention.

FIG. 5 shows one embodiment of a device according to the present invention connected with a smartphone.

FIG. 6 shows a bracelet according to the present invention coupled to both smart glasses and a smartphone.

FIG. 7 shows a block diagram which illustrates the computer processes associated with the method of the present invention.

FIG. 8 shows another embodiment of a device according to the present invention, wherein the device is integrated into the wrist portion of a shirt worn by the user.

FIG. 9 shows different clasping embodiments for the present invention.

FIG. 10 shows the device in a bracelet form and also worn by a user.

FIG. 11 shows the device and method as it functions in terms of input and output.

FIG. 12 shows other possible inputs.

FIG. 13 shows various outputs put out as a stimulus.

FIG. 14 shows the device in communication with a remote device.

FIG. 15 show a conducting band composed of conducting and non-conducting elements.

FIG. 16 shows the device as part of a necklace. In one embodiment the necklace chain is made of conductive material to provide an electric shock around the user's neck.

FIG. 17 shows the device and method outputting multiple stimuli and multiple stimulating units.

### DETAILED DESCRIPTION OF THE PREFERRED EMBODIMENT

“Simultaneously,” as used throughout herein, is defined as the time period beginning approximately five (5) seconds before each step of memorizing, continuing through the step of memorizing, and ending approximately five (5) seconds after each step of memorizing; thus, this terminology may also be read as “simultaneously or within five seconds of” any particular informational or habitual event discussed herein.

One utility of the present invention is to help to memorize any sensory information received by an individual. Another purpose of the same invention is to assist individuals with the formation and/or the cessation of a habitual behavior, for example, exercising regularly, reading regularly, eliminating smoking, or eliminating biting of the nails.

The present application for invention discloses methods (and devices for performing the methods) comprising the administration of a sensory impact or Stimulus—a mild electric jolt, a vibration, a light, a sound, a smell, heat or cold—on a human or animal user to facilitate that user's capability of memorizing information (memory enhancement) and/or creating or eliminating habitual behavior (habit training). The devices used may include the following non-limiting examples: bracelets, anklets, rings, wristbands, attachments or adhesives, part of a garment, carried items, clothing, and inserts for wearable and carried items.

With regard to memory enhancement, the impact or the stimulus creates a supplemental emotional response in the user which, when performed simultaneously with, or sufficiently near in time to, the receiving and processing of particular information, leads to an improved capability to remember that information (i.e., improved memory formation).

With regard to habit training, the impact or stimulus acts to remind/punish or encourage/reward a user wearing or carrying the device, similarly creating an additional emotional response when the habit is performed or avoided, all programmable according to the user's preference.

Stimulus-Induced Memory Enhancement

Experiencing mild shocks or other stimuli while learning enhances related memories (i.e., those memories which are made or processed at the same time or sufficiently near in time to the stimulus). The enhancement occurs because of the activation of another portion of the brain, which creates a supplemental emotional response in addition to the normal neurological response of an individual when her or she hears and processes information. This additional emotional event has a very specific enhancing effect on remembering the information received. This is because the brain is stimulated in at least two sections, rather than just one (the emotional response from the sensory signal in one portion of the brain, and the usual informational response in another portion, from receiving a fact (or facts)). The enhancement also occurs because both stimulations of the brain occur at the same time, thus creating an additional connection and memory within the brain. Of course, using electrical shocks, even mild ones, isn't the only option, there exist other stimuli, including either punishing or rewarding.

Various devices which create varying stimuli may be used to implement the above principle. In the preferred embodiment of the present invention, a user wears a bracelet which provides a sensory impact—a mild electroshock, a vibration, or both. In other embodiments, some which may be preferred depending on the subject's personality, the sensory impact may comprise a mild electroshock, a vibration, a sound, flashing LEDs, or any combination thereof and administered in any order.

Stimulus-Induced Habit Training and Other Informational Alerts

Habit training methods employed via the device of the present invention further help the user form a habit, break a bad habit, or otherwise assist to train a user on a skill or behavior via manual or automatic stimulus administration, based on the program selected or created by the user.

The device may indicate alerts via various stimuli which notify or induce emotion in the user.

In various embodiments, the device may create the following types of sensory impacts upon the user: display text on an LED screen; emit a sound; shine a light; vibrate or induce a shock (electrical or static). In various embodiments, the device may include a sensor or multiple sensors to measure caloric intake or other nutritional or health-related information; include a microphone to accept audio input from the user; include a magnetometer to identify cardinal direction; include an accelerometer to identify motion and sleep data.

The device may be used as an assistive habit-formation device (positive or negative reinforcement), it can be used as an assistive habit-breaking device (classical conditioning, punishment at the instant of doing an activity), or alternatively as a behavioral training device (physical feedback indicating how a user should improve or change their action).

The positive reinforcement may be heat, cool, a slight vibration to the wrist, or a TENS (Transcutaneous electric nerve stimulation) electric stimulation, which feels like a massage.

For example, an alert may be sent to a user when the user spends a threshold amount of time browsing a social network (notifying the user that they should stop the bad habit, eventually punishing the user if they do not stop).

In the above example, the software works in the following manner the software detects the usage of a website which the user desires to browse less often (this is programmable by the user or otherwise customizable, based on user preference). The software uses an API provided by 3rd party vendors. An application programming interface (API) is a protocol intended to be used as an interface by software components to communicate with each other. An API includes specifications for routines, data structures, object classes, and variables. An API specification takes many forms, including an International Standard such as POSIX, vendor documentation such as the Microsoft Windows API, the libraries of a programming language, e.g. Standard Template Library in C++ or Java API. Thus, when a user uses a particular website (programmed into the computer software according to user preference), the other API signals to the device that the user is browsing the website. The software on the device itself takes note of this, and signals one or more of various actions. It may, for example, begin to account and deduct time from the user's allotted browsing time, signal the user at various points to notify of time spent browsing and/or punish the user for exceeding a set limit (via any impact or stimulus), or signal the computer to disable the website from use entirely. Sensors built into the user's device and/or computer allow for automatic detection of parameters and automatic signaling and stimulation. The user may also manually administer any stimulus or impact at any point.

Additionally, the user may program the device for an alert simply when he or she is facing directly north. This use is a more simple notification but helpful for training one's orientation. No punishment is necessary in such a case, since this is only used for informative or skill training.

In another exemplary embodiment, the method performed by the device comprises determining the total caloric intake in a user's diet. The device may provide various reminders, notifications, and shocks when a user is approaching and exceeds a predetermined caloric threshold (set by the user or suggestively programmed beforehand).

In general, the devices may use a separate or integrated sensor(s) to provide various feedback, reminders, notifications, or punishment when those sensors approach and exceed a threshold limit of detected input. The threshold and overall programs for various habits may be set up by the user, the software, or the device itself. Furthermore, the user may manually create stimuli via the device, or set an automatic stimulus program using an integrated sensor or other detecting mechanism.

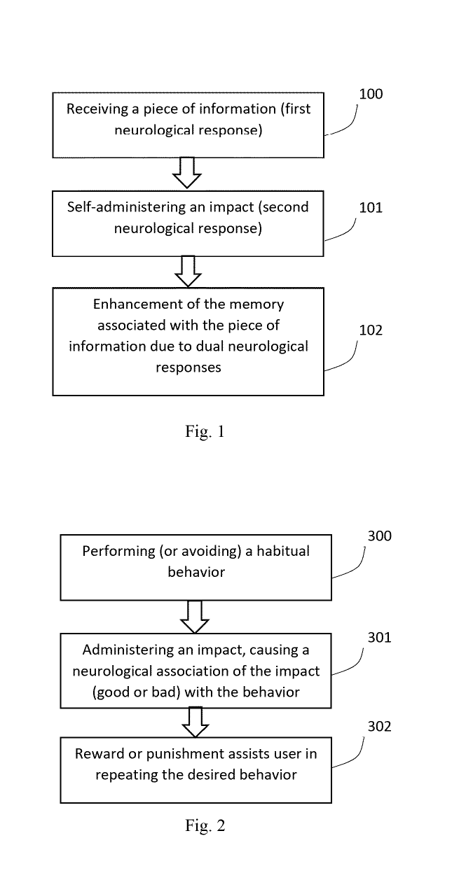

FIG. 1 shows the steps of one embodiment of the method disclosed by the present invention. Initially, a user hears or otherwise receives a piece of information 100. After, during, or before receiving that piece of information, a user self-administers a mild electroshock 101, which facilitates memorizing the piece of information (thus enhancing the memory 102) by linking the received information with the additional emotional response from the stimulus. For example, a user may induce a stimulus every time he or she meets an individual at a networking event. Remembering the names of multiple important people at such events is difficult, yet such information is of crucial importance to business. By administering an additional sensory impact, thus creating a supplemental emotional response and link to the received information within the user's brain, the user naturally and physically improves his or her formation of each memory combined with a sensory impact. When the user later attempts to retrieve the previously acquired information, recollection is easier due to the additional neurological connection that was created at the same time (or at a time significantly near in time) as the initial receiving and processing of that information. In this example, the received information is verbal information—this is a non-limiting example and any memory, verbal or other, may be enhanced using similar methodologies and devices.

FIG. 2 shows the steps involved in another embodiment of the present invention, where a user desires to train habitual behavior. Initially, the user wishes to either gain a beneficial habitual behavior, such as regular gym attendance, or avoid detrimental habitual behavior, such as smoking. By wearing or carrying a device according to the present invention and administering the method using the device, the user may reach a desired level of the desired behavior. Thus, when the user performs a beneficial behavior 300, an impact may be administered (either automatically or manually) to create a good neurological response as a reward 301. Alternatively, if a beneficial behavior is not performed, a different impact may be administered to associate a bad neurological response as a punishment (either automatically or manually) 301. The reward or punishment, based on the behavior of the user, thus assists the user in attaining desired behavior characteristics 302.

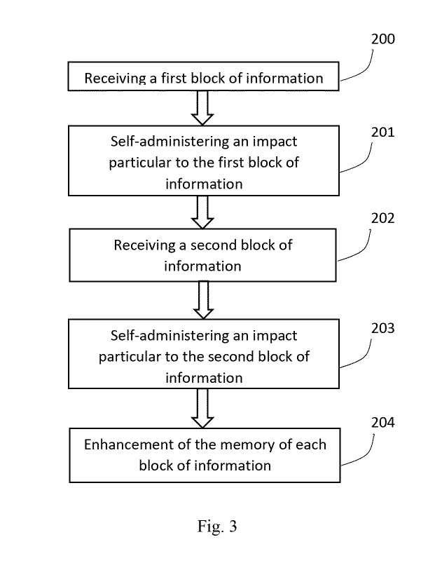

FIG. 3 shows an example of the series of steps required when a user desires to memorize larger volumes of information (i.e., not just a single packet of information such as a name). For example, this may occur when a student is preparing for an exam by reading information in various chapters or various books. The method then calls for a sensory impact to be administered simultaneously with the time that a particular block or portion of information is received and processed by the student. Once each block or portion of information is processed by the user 200, 202, the user may administer a sensory impact in order to better remember the particular information of that block 201, 203. Furthermore, the user may administer varying sensory impacts which help recall different blocks of information. For example, a vibration may be induced during the learning of a first chapter of a book, while a shock is induced during the learning of the second chapter and thus another block of information. The administration of the impacts during the learning alone, with nothing more, is sufficient to enhance the memory of each block of information 204. However, when the same impact is later administered again, it further assists the user in remembering information processed from the chapter associated with the stimulus because the supplemental emotional response from that particular vibration is linked, via time and other pathways in the user's brain, to that particular information. Similarly, when the same shock is later administered, it assists the user in recollecting information processed from the second chapter (due to a different supplemental emotional response linked to the second block of processed information). There is no limit as to the number of blocks of information, the number sensory impacts administered, or the varying types of sensory impacts available (e.g., various vibration or shock patterns for various blocks of information). The sensory impacts may also include, e.g., motivating or encouraging sounds or other auditory bits, releases of particular smells (both pleasant and unpleasant, based on user preference), hot or cold temperature sensations, motivating or encouraging LEDs or text displays, and all other known or obvious sensory stimuli (e.g., verbal, visual, auditory, olfactory, tactile, etc.).

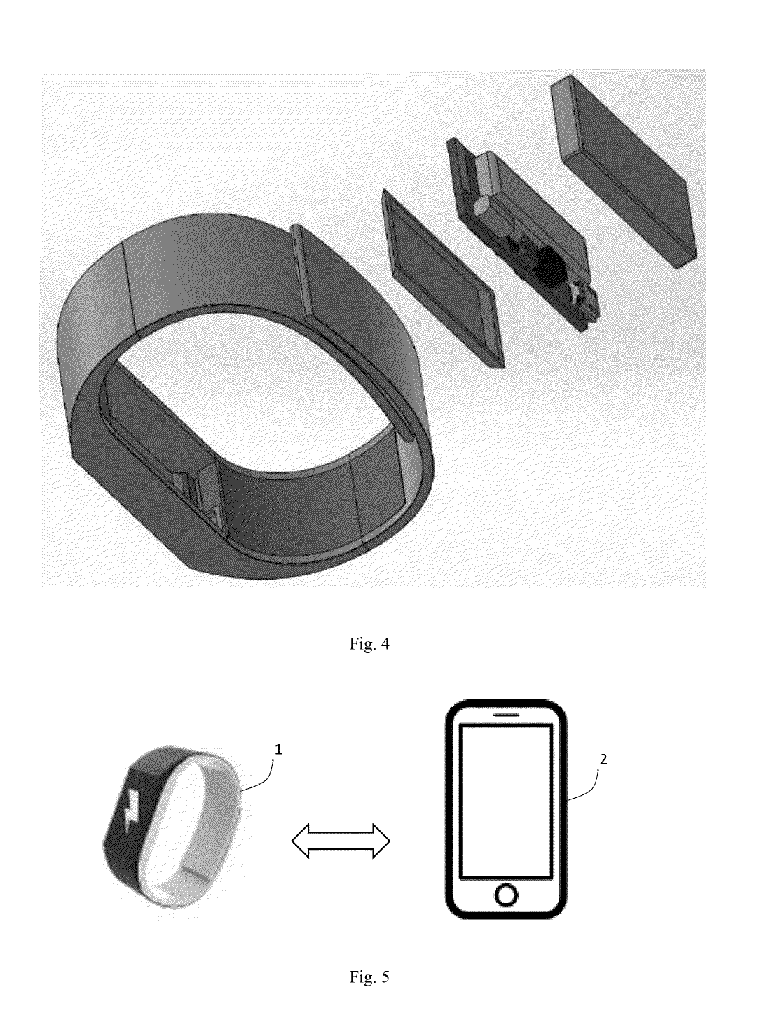

In the preferred embodiment of the invention, the impact is self-administered by a user via pressing a button on his/her bracelet- the preferred embodiment for the bracelet is shown in FIG. 4, where the integral parts of the bracelet are shown in an exploded view. Other embodiments of the method may comprise pressing a button on a linked device, such as a smart phone or other computer, programming the device to administer an automatic stimulus in response to particular criteria and input detected by the device, or the use of devices other than bracelets, such as anklets, clothing, rings, and other portable (e.g., handheld or otherwise carried) items not limited to bracelets and buttons.

The device is preferably connected via a wireless connection to the user's smartphone, tablet, or computer. In the preferred embodiment, as shown in FIG. 5, a bracelet 1 is connected to a smartphone 2, wherein the bracelet is controllable via a program installed on the smartphone and linked to the device via wireless or Bluetooth connection. The user alternatively may download an application to his/her smartphone that allows for control of the sensory impact via the bracelet using a radio signal. Furthermore, the settings for stimulus administration may also be varied on the device itself (i.e., the bracelet, rather than the smartphone or other linked computer) via a screen with multiple buttons or a touch screen.

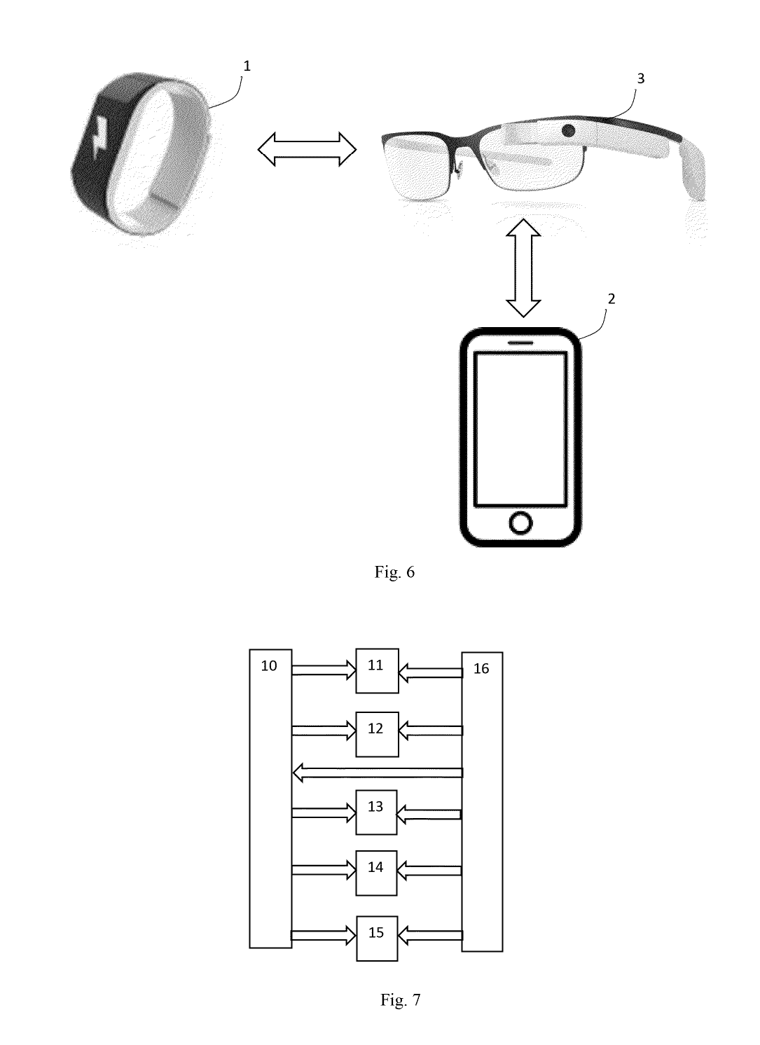

In another embodiment, as shown in FIG. 6, a bracelet 1 is connected to a smartphone or other computer 2 via smart glasses 3 (e.g., Google Glasses, Myo, etc.), as shown in FIG. 4. In this example, a certain gesture performed by the user and registered by the glasses may serve in place of the “button(s)” for administering the sensory impact on the user. In this and similar embodiments, it is also possible for the device to administer an automatic stimulus upon the user in response to a behavior or gesture automatically detected by the glasses. The sensory impact administered may be triggered, also, e.g., by an internal accelerometer The gesture of the user's motion, for example, can be registered by the glasses, thus identifying when the user might be performing a detrimental behavior (e.g., smoking) and administering a stimulus. Similar technology not limited to smart glasses may be used in a similar manner to replace the need for a physical button or the need for self-administration. The settings for stimulus administration may similarly be varied on the device itself (i.e., the bracelet or other device, rather than the smart glasses or other linked device) via a screen with multiple buttons or a touch screen.

One embodiment of the circuitry used according to the present invention is shown in FIG. 7. The bracelet is equipped with a Bluetooth transceiver 10, a vibration unit 11 having a mini vibration motor, an electroshock unit 12 including a capacitor and contacts for administering an electrochock, a light unit 13 having LED lights, loudspeakers 14, a display 15, and a battery 16. The Bluetooth transceiver 10 controls operation parameters of the vibration motor, the capacitor charge level, the light intensity, the loudspeaker volume, and the message shown on the display. The battery 16 provides power for all the elements.

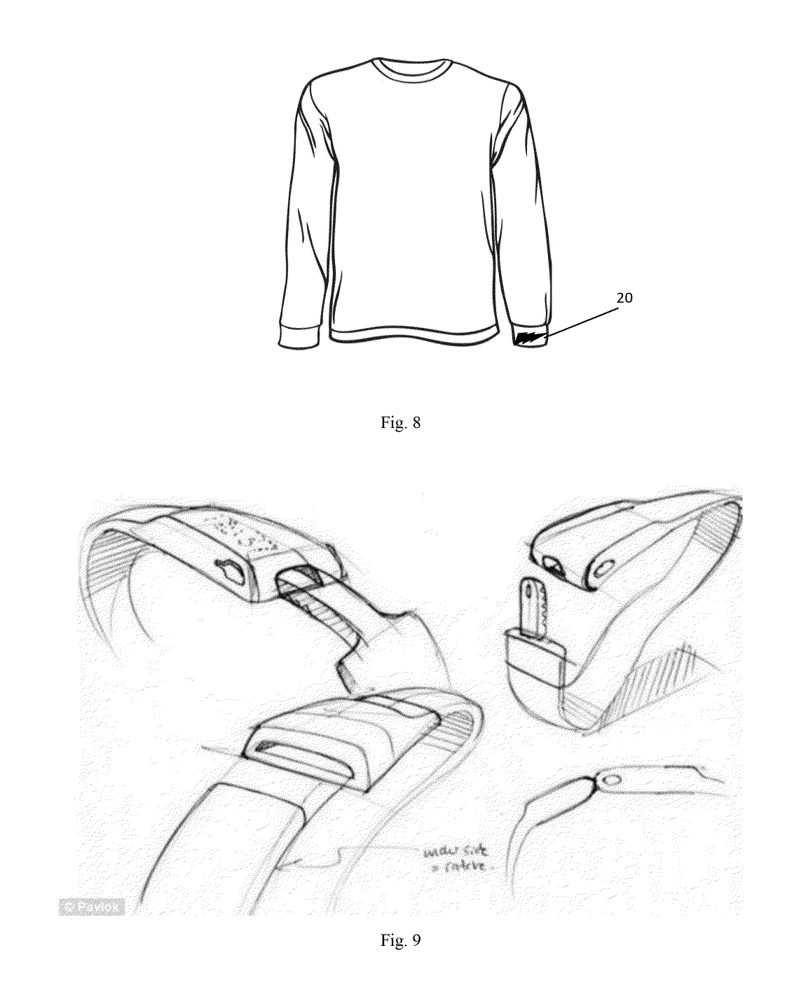

In another embodiment of the present invention, illustrated in FIG. 8, the device 20 is integrated as a part of a garment—in this case, it is integrated into the wrist portion of a shirt worn by the user. In the general case, the integrated device may be located on any part of any wearable garment.

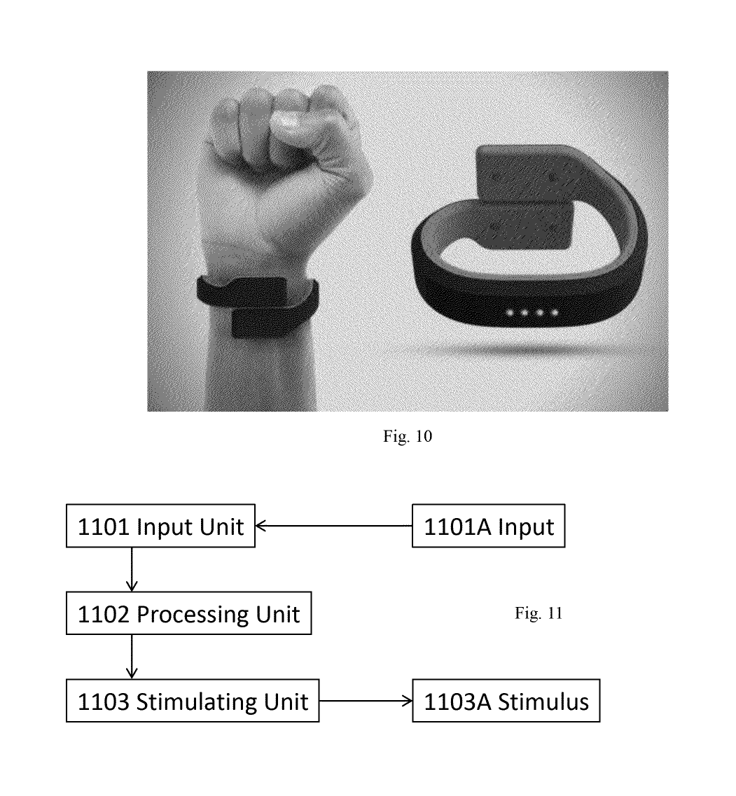

FIG. 9 shows different clasping embodiments for the present invention. FIG. 10 shows the device in a bracelet form and also worn by a user.

FIG. 11 shows a device for behavioral feedback for training behavior, that includes an input unit 1101, a stimulating unit 1103 for impacting a user wearing said device with a stimulus 1103A, said stimulus being given as feedback to a user action, said stimulus forming a physical or emotional response within the user, said physical or emotional response being linked in time and place to said receiving of information, thus reinforcing, positively or negatively, the user action within the user's brain.

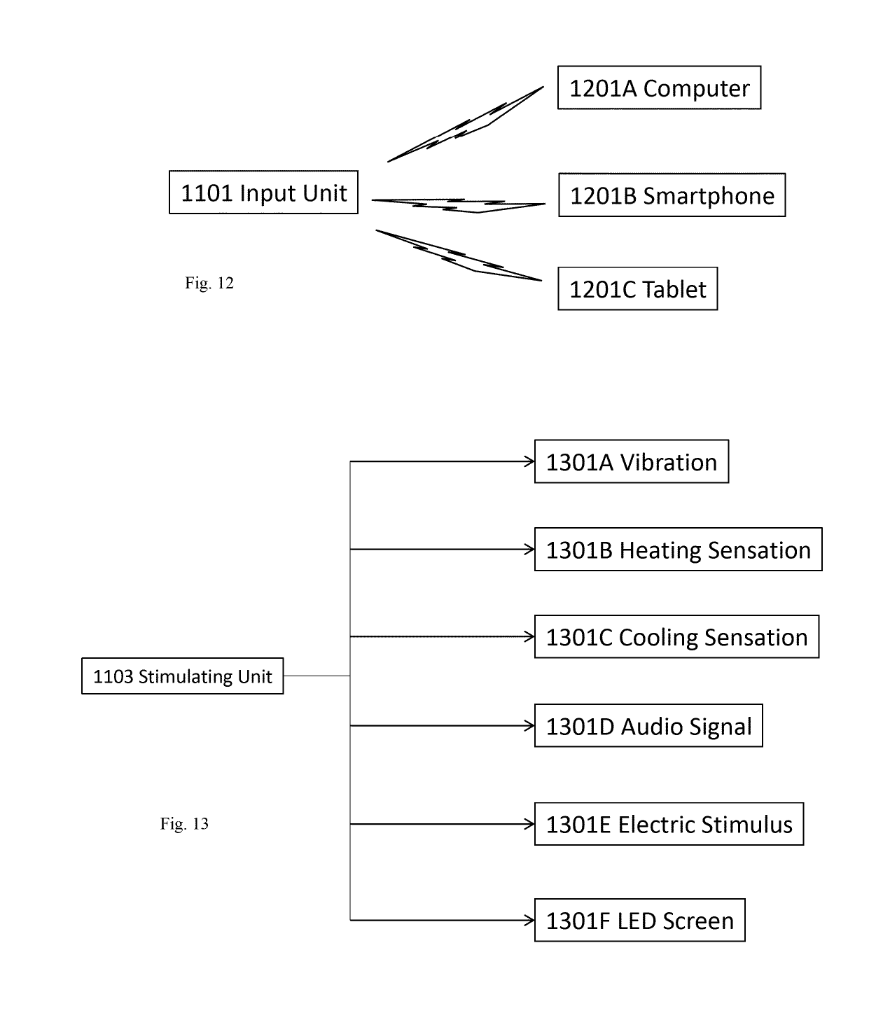

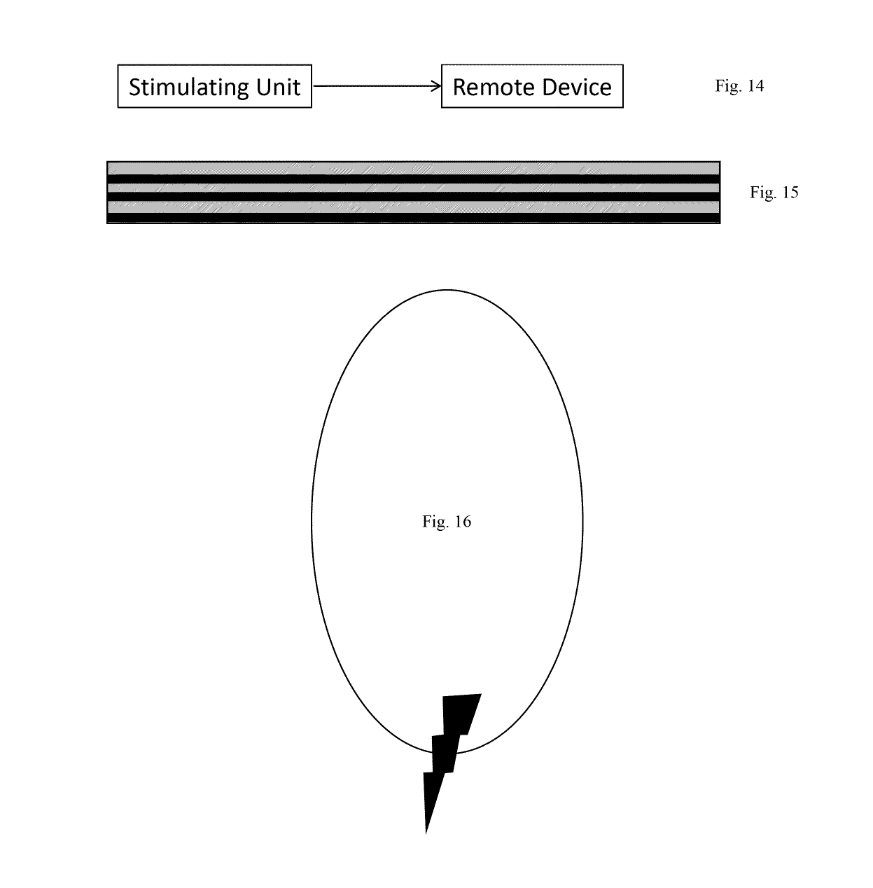

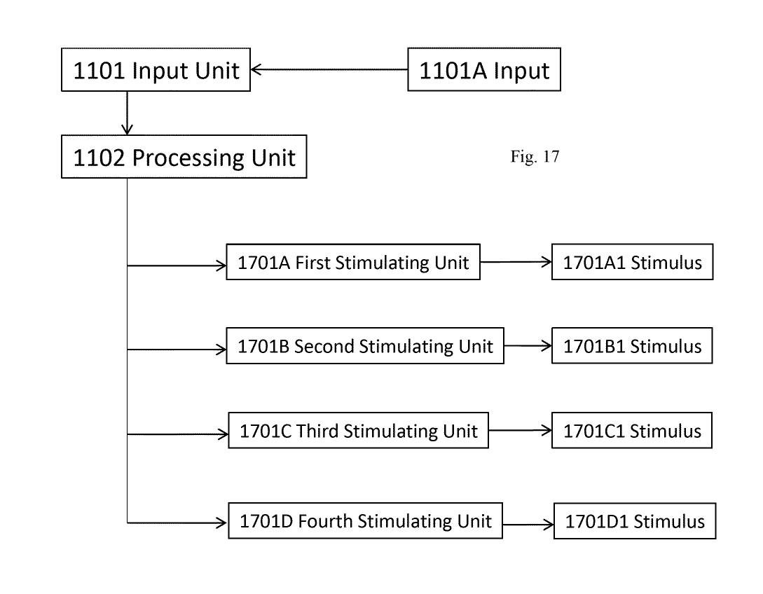

The device wherein the input unit 1101 receives input 1101 A as a signal from another electronic device. The device wherein the other electronic device is a computer 1201A, smartphone 1201B , or tablet 1201C (FIG. 12). The device wherein the stimulus is the device vibrating 1301A, the device heating at a contact point with the user 1301B, the device cooling at a contact point with the user 1301C, the device providing an audio signal to the user 1301D, or the device administering an electric stimulus to the user 1301E (FIG. 13). The device wherein the stimulus is administered in varying degrees of intensity. The device wherein the stimulus is provided via a LED screen 1301F (FIG. 13). The device wherein the stimulus is provided via a remote controlled device (FIG. 14). The device wherein the input unit 1101 is a sensor that detects biological signals (FIG. 11). The device wherein the input unit 1101 is an accelerometer (FIG. 11). The device where the input gyroscope is built into the accelerometer or a 6-axis accelerometer (FIG. 11). The device where the input magnetometer is built into the accelerometer or a 9-axis accelerometer (FIG. 11). The device wherein the input unit 1101 is a gyroscope. The device wherein the input unit is a compass (FIG. 11). The device wherein the input unit 1101 is a magnetometer (FIG. 11). The device further including a conductive band that can propagate the stimulus, provide additional surface area for the input unit, or both (FIG. 15). The band wherein the conductive material or conductive silicone is interspersed with a non-conductive material or standard silicone (FIG. 15). The device wherein the device is worn by the user as a module housed in a silicone band (FIGS. 4 and 10). The device wherein the device is worn by the user as a module 20 housed in an article of clothing (FIG. 8). The device wherein the device is worn by the user as a module that is housed as an attachment to a watch or watchband. The device wherein the device is worn by the user as a module housed in a necklace attachment (FIG. 16). The device wherein the device is integrated into a watchband or bracelet (FIG. 9). The device wherein the device is built directly into a watch strap that can be attached directly to other watches or smart watches (FIG. 9). The device further comprising a second stimulating unit 1701B for impacting a user wearing said device with a second stimulus 1701B1 (FIG. 17). The further comprising a third stimulating unit 1701C for impacting a user wearing said device with a third stimulus 1701C1 (FIG. 17). The device further comprising a fourth stimulating unit 1701 D for impacting a user wearing said device with a fourth stimulus 1701D1 (FIG. 17). The device wherein said stimulus forming said physical or emotional response within the user, said physical or emotional response being linked in time and place to said receiving of information, thus reinforcing, positively or negatively, the user action within the user's brain thus forming a sixth sense for the user.

FIG. 11 shows a method for behavioral feedback training of behavior, including placing a device 1101, 1102, and 1103 (integrated in a single device, or across multiple devices) on a user's wrist, an input 1101A is received by the device, the device providing a stimulus 1103A to the user as feedback to a user action, said stimulus forming a physical or emotional response within the user, said physical or emotional response being linked in time and place to said receiving of information, thus reinforcing, positively or negatively, the user action within the user's brain.

The method of wherein the input 1101 A is an input signal from another electronic device. The method wherein the input signal 1101A is received from a computer 1201A, smartphone 1201B, or tablet 1201C (FIG. 12). The method wherein the stimulus 1103A is the device vibrating 1301A, the device heating at a contact point with the user 1301B, the device cooling at a contact point with the user 1301C, the device providing an audio signal to the user 1301D, or the device administering an electric stimulus to the user 1301E (FIG. 13). The method wherein the stimulus is administered in varying degrees of intensity. The method wherein the stimulus is provided via a LED screen 1301F (FIG. 13). The method wherein the stimulus is provided via a remote controlled device (FIG. 14). The method wherein the input 1101A is from a sensor that detects biological signals (FIG. 11). The method wherein the input unit 1101 is from an accelerometer (FIG. 11). The method where an input gyroscope is built into the accelerometer or a 6-axis accelerometer (FIG. 11). The method where an input 1101 A magnetometer is built into the accelerometer or a 9-axis accelerometer (FIG. 11). The method wherein the input 1101A is from a gyroscope (FIG. 11). The method wherein the input 1101A is from a compass (FIG. 11). The method wherein the input 1101A is from a magnetometer (FIG. 11). The method wherein the stimulus 1301A is propagated along a conductive band, providing additional surface area for receiving the input, or both (FIG. 15). The method wherein the conductive band or conductive silicone is interspersed with a non-conductive material or standard silicone (FIG. 15). The method wherein the device is worn by the user as a module housed in a silicone band (FIG. 14). The method wherein the device is worn by the user as a module 20 housed in an article of clothing (FIG. 8). The method wherein the device is worn by the user as a module that is housed as an attachment to a watch or watchband. The method wherein the device is worn by the user as a module housed in a necklace attachment (FIG. 16). The method wherein the device is integrated into a watchband or bracelet (FIG. 9). The method wherein the device is built directly into a watch strap that can be attached directly to other watches or smart watches (FIG. 9). The method including a second stimulus 1701B1 is provided to the user (FIG. 17). The method including a third stimulus 1701C1 is provided to the user (FIG. 17). The method including a fourth stimulus 1701D1 is provided to the user (FIG. 17). The method wherein said stimulus forming said physical or emotional response within the user, said physical or emotional response being linked in time and place to said receiving of information, thus reinforcing, positively or negatively, the user action within the user's brain thus foil ling a sixth sense for the user.

The software that the user installs on his/her computer allows the user to set goals for the program linked with the device and its administration of sensory impacts. If the user fails to follow through on a goal, he receives a reminder and/or punishment, as programmed by the user into the software, which communicates with the device worn or carried by the user.

In summary, the device is a wearable instrument that aids in the use of training and reinforcing habits, using a variety of reminder mechanisms, as well as assisting the user in remembering previously received and processed information.

The following non-limiting examples further elicit the utility of the present invention:

A user doesn't want to use Facebook for more than 20 minutes a day. So, he sets a reminder on his computer to not allow him to. After 20 minutes, he feels a vibration. After 40 minutes, he starts getting shocked—and cannot get back on the laptop. Alternatively, A parent might want her son to use Facebook for more than 15 minutes a day. So, she installs the bracelet software on his computer. Whenever he uses the computer for over 15 minutes, the bracelet will vibrate strongly, teaching her son to stop using the social network.

A user wants to train himself to write at 9 AM every day. If, at 9 AM, he is not in his ‘writing app’ on his computer, he will get shocked.

A user wants to stop browsing reddit.com, so every time he gets on it, the device shocks him. The user locked the bracelet and gave the key to another so he wouldn't be able to simply remove the item from his body.

A user doesn't want to eat more than 2,000 calories per day. He sets this number in the bracelet software on his computer. As he continues to eat throughout the day, the sensor in the bracelet tracks how many calories he's consuming. When he's getting close to his limit, the bracelet warns him. If he exceeds it, the bracelet shocks him.

A user is a diabetic who must watch his glucose intake. As he eats throughout the day, the sensor in the watch (glucometer) tracks his blood sugar and alerts him when he is in danger of going too high or too low.

A user is trying to overcome his heroin addiction. He's undergoing therapy in an in-house treatment facility. The sensor on the watch tracks the compounds in his blood stream to detect if he's taking any illegal narcotics, and sends the results instantly to the physicians in real time, without the need for them to perform any bloodwork to obtain results. Alternatively, the physician, or the device itself, is capable of administering an impact to remind and/or punish the user for particular behaviors.

A user is a 3rd grade teacher who wants to stop swearing in front of her students.

The vocal recognition sensor in the watch tracks how many times she uses profanity (based on a list compiled by her) and uses the feedback to inflict a penalty when necessary (shock, money deducted from an account, etc.).

A user is a soldier in the U.S. military. He begins to wear the device, which tracks his compass direction and vibrates whenever he faces north. He intuitively begins to improve his directional capabilities and orientation skills. The device is used as a sensor and feedback monitor to help train his orientation instincts and skills.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

1. A method for training of behavior, comprising:
a. placing a device on or near a user;
b. an input is received or triggered by the device;
c. the device providing a stimulus to the user as feedback;
d. said stimulus forming a physical or emotional response within the user, said physical or emotional response being linked in time and place to said receiving of information, thus reinforcing, positively or negatively, the user action within the user's brain.

2. The method of claim 1, wherein the input is an input signal from another electronic device.

3. The method of claim 2, wherein the input signal is received from a linked device, including a computer, smartphone, sensor, or tablet.

4. The method of claim 1, wherein the stimulus is the device vibrating, the device heating at a contact point with the user, the device cooling at a contact point with the user, the device providing an audio signal to the user, or the device administering an electric stimulus to the user.

5. The method of claim 4, wherein the stimulus is administered in varying degrees of intensity.

6. The method of claim 1, wherein the stimulus is provided via a LED screen.

7. The method of claim 1, wherein the input is provided via a remote controlled device.

8. The method of claim 1, wherein the input is from a sensor that detects various signals.

9. The method of claim 1, wherein the input unit is from an accelerometer.

10. The method of claim 9, where an input gyroscope is built into the accelerometer or a 6-axis accelerometer.

11. The method of claim 9, where an input magnetometer is built into the accelerometer or a 9-axis accelerometer.

12. The method of claim 1, wherein the input is from a gyroscope.

13. The method of claim 1, wherein the input is from a compass or magnetometer.

14. The method of claim 1, wherein the stimulus is propagated along a conductive band, providing additional surface area for receiving the stimulus or input.

15. The method of claim 14, wherein the conductive band or conductive silicone is interspersed with a non-conductive material or standard silicone.

16. The method of claim 1, wherein the device is worn by the user as a module housed in a silicone band.

17. The method of claim 1, wherein the device is worn by the user as a module housed in an article of clothing.

18. The method of claim 1, wherein the device is worn by the user as a module that is housed as an attachment to a watch or watchband.

19. The method of claim 1, wherein the device is worn by the user as a module housed in a necklace attachment.

20. The method of claim 19, wherein the device propagates an electric stimulus through a chain of the necklace, such that the stimulus is felt on a user's neck.

21. The method of claim 1, wherein the device is integrated into a watchband or bracelet.

22. The method of claim 21, wherein the device is built directly into a watchstrap that can be attached directly to other watches or smart watches.

23. The method of claim 1, a second stimulus is provided to the user.

24. The method of claim 23, a third stimulus is provided to the user.

25. The method of claim 24, a fourth stimulus is provided to the user.

26. The method of claim 1, wherein said stimulus, via automatic input triggers, forms a sixth sense for the user.

27. The method of claim 26, wherein said stimulus automatically triggering based on its input, thus subconsciously notifying or teaching the user of information.
